(19) United States
(12) Patent Application Publication
(10) Pub. No.: US 2011/0215269 A1
(43) Pub. Date: Sep. 8, 2011

(54) PRESSURE CONTROL VALVE

(75) Inventors: Thomas H. Fischer, Rochester, NY (US); Michael J. Dinkel, Penfield, NY (US)

(73) Assignee: DELPHI TECHNOLOGIES, INC., Troy, MI (US)

(21) Appl. No.: 12/718,013

(22) Filed: Mar. 5, 2010

(51) Int. Cl. F16K 31/02

(52) U.S. Cl. 251/129.15

(57) ABSTRACT

A switchable valve assembly is provided with a housing having a longitudinal bore with a spool disposed therein. The spool is selectively positioned within the longitudinal bore for controlling the flow of working fluid between a supply port and a control port and between the control port and a vent port. An actuator assembly is provided for selectively positioning the spool in the longitudinal bore. The actuator assembly includes a connecting rod for mechanically transmitting linear motion to the spool when switching from at least one valve mode to another valve mode. The connecting rod is structurally separate from the spool.

### TECHNICAL FIELD OF INVENTION

The present invention relates to spool-type valves; and more particularly, to such valves as are commonly employed for switching and controlling flow of activation and lubrication fluids to various components of internal combustion engines; and most particularly, to switchable oil control valves having a spool for regulating oil pressure and for switching between high pressure mode and pressure relief mode.

### BACKGROUND OF INVENTION

Spool-type valves for controllably diverting the flow of fluids are well known. In a typical spool valve, a piston or “spool,” having a plurality of annular grooves in the spool wall is slidably disposed within a cylindrical body that is also provided with a plurality of internal annular grooves and radial ports extending through the body wall. The spool is variably positionable axially within the body to cause selected ports in the spool to align with grooves and ports in the body, thereby permitting flow of fluid from outside the body through first aligned ports into the interior of the spool and out through second aligned ports. A plurality of different flow paths typically is created by positioning the spool at a plurality of different axial positions within the body. Typically, the spool is connected to a linear solenoid actuator, whereby the spool may be axially positioned by signals from a controller such as a computerized engine control module, although other actuators such as pneumatic and hydraulic actuators can be used.

A common usage for an oil-control spool valve is to variably actuate engine control subsystems such as camshaft phasers, variable valve activation (VVA) mechanisms, and multi-step or valve deactivation mechanisms. In a two step valve mechanism, for example, the mechanism selects the engine intake valve lift profile (low or high) of an intake valve camshaft using a hydraulically activated roller finger follower (RFF).

In a simple configuration of this example, a spool valve supplies high pressure oil, typically from an engine-driven oil pump, to activate the RFF, and shuts off the oil supply to deactivate and drain pressure from the RFF. However, it is desirable that in RFF-deactivation mode the oil supply not be completely shut off, as other components of the valve train, such as camshaft lobes and rocker arms, continue to require flow of oil for lubrication.

U.S. Pat. No. 6,904,937 discloses a piloted spool-type valve that is switchable not simply between on and off modes but also between a pressure high enough for RFF activation and a controlled pressure sufficient for lubrication but insufficient for RFF activation. A piloted spool-type valve requires two spools to function; a regulating spool and a pilot spool. The regulating spool controls a relatively high flow of working fluid through the valve by being axially displaced in the valve. A high force is required to axially displace the regulating spool because of the high hydraulic force acting on the regulating spool as a result of the high flow of working fluid being directed by the regulating spool. The force required to axially displace the regulating spool is higher than can practically be supplied by a mechanical actuator. The pilot spool is therefore provided to be axially displaced in the valve in order to direct a low flow of working fluid which in turn axially displaces the regulating spool. A mechanical actuator can provide the force needed to axially displace the pilot spool in the valve since the pilot spool is subjected to a smaller hydraulic force from the working fluid because of the low flow of working fluid being directed. While a piloted spool-type valve works well in an application with a relatively high flow requirement, a piloted spool-type valve adds unnecessary complexity and expense when used in an application that has lower flow requirements and thus produces lower hydraulic forces on the regulating spool.

What is needed is a simpler, direct-acting, i.e. non-piloted, oil control valve assembly that is switchable not simply between on and off modes but also between a pressure high enough for RFF activation and a controlled pressure low enough for lubrication but insufficient for RFF activation.

### SUMMARY OF THE INVENTION

Briefly described, the present invention provides a valve assembly having a housing with a longitudinal bore. The bore receives working fluid from a working fluid source through a supply port, sends working fluid to and from a working device through a control port, and returns working fluid to the working fluid source through a vent port. A spool slideably disposed in the longitudinal bore controls the flow of working fluid between the supply port and the control port and between the control port and the vent port. An actuator assembly moves the spool axially within the longitudinal bore in order to select the desired valve mode of high pressure mode, pressure relief mode, or pressure regulating mode. A solenoid of the actuator assembly produces linear motion and a connecting rod structurally separate from the spool mechanically transmits linear motion from the solenoid to the spool when switching from at least one of the valve modes to another of the valve modes. A pressure regulating spring may be provided to bias the spool away from the actuator assembly.

When high pressure mode is selected, the spool is positioned in the longitudinal bore such that the control port is not in fluid communication with the vent port while the supply port is in fluid communication with the control port. High pressure mode allows full pressure from the working fluid source to be applied to the control port.

When pressure relief mode is selected, the spool is positioned in the longitudinal bore such that the supply port is not in fluid communication with the control port while the control port is in fluid communication with the vent port. Pressure relief mode causes pressure to be relieved from the control port. When this happens, the working fluid is allowed to flow to the vent port and back to the working fluid source.

When pressure regulating mode is selected, the spool is positioned in the longitudinal bore such that the control port is not in fluid communication with the vent port while the supply port is in fluid communication with the control port such that fluid at the control port is regulated to a pressure that is less than pressure at the supply port.

Further features and advantages of the invention will appear more clearly on a reading of the following detail description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a cross section of a valve assembly in accordance with the present invention;

FIG. 2 is a cross section of a valve assembly positioned in high pressure mode in accordance with the present invention;

FIG. 3 is a cross section of a valve assembly positioned in pressure relief mode in accordance with the present invention;

FIG. 4 is a cross section of a valve assembly positioned in pressure regulating mode in accordance with the present invention; and

FIG. 5 is a cross section of a second embodiment of a valve assembly in accordance with the present invention.

### DETAILED DESCRIPTION OF INVENTION

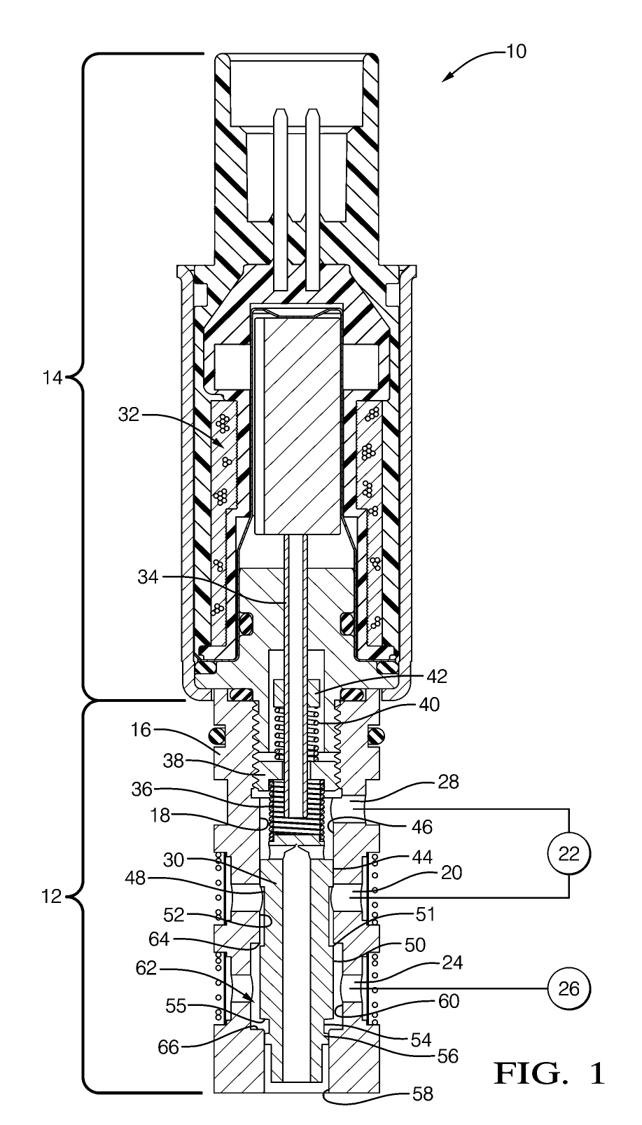

In accordance with a preferred embodiment of this invention and referring to FIG. 1, a valve assembly 10 is shown. Valve assembly 10 includes spool valve assembly 12 which is connected to actuator assembly 14. Spool valve assembly 12 includes housing 16 with longitudinal bore 18. Supply port 20 is provided in fluid communication with longitudinal bore 18 for selectively receiving working fluid from working fluid source 22. Control port 24 is provided in fluid communication with longitudinal bore 18 for selectively communicating working fluid to and from working device 26. Vent port 28 is provided in fluid communication with longitudinal bore 18 for selectively returning working fluid to working fluid source 22.

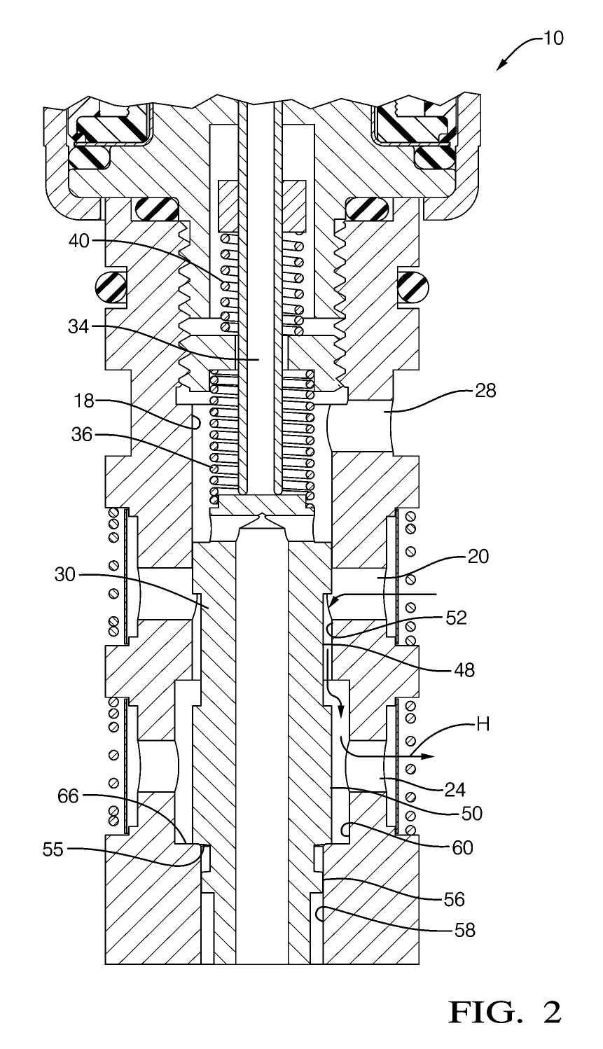

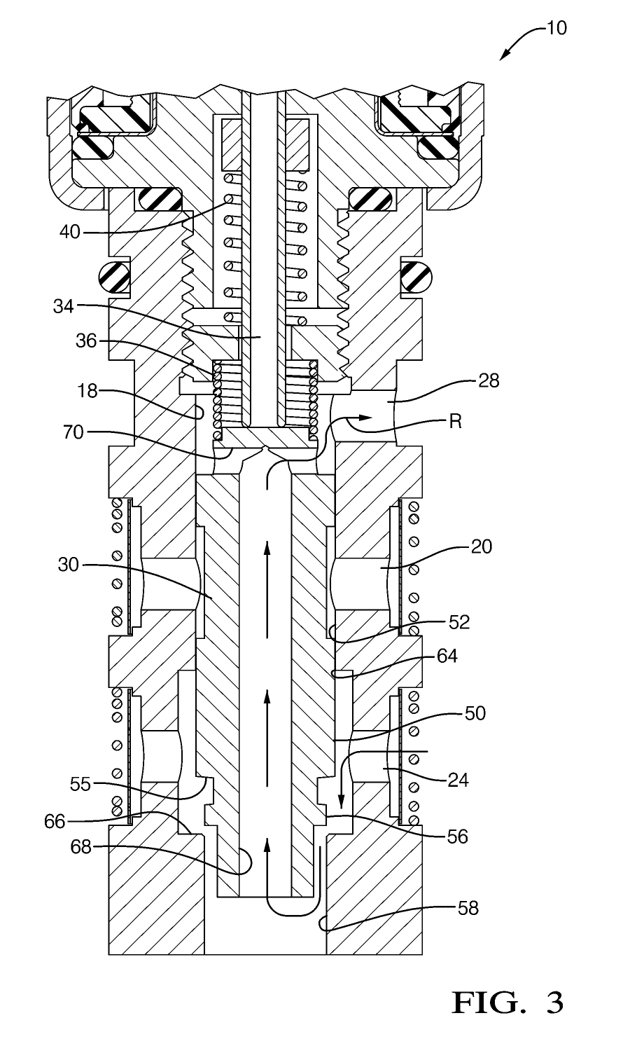

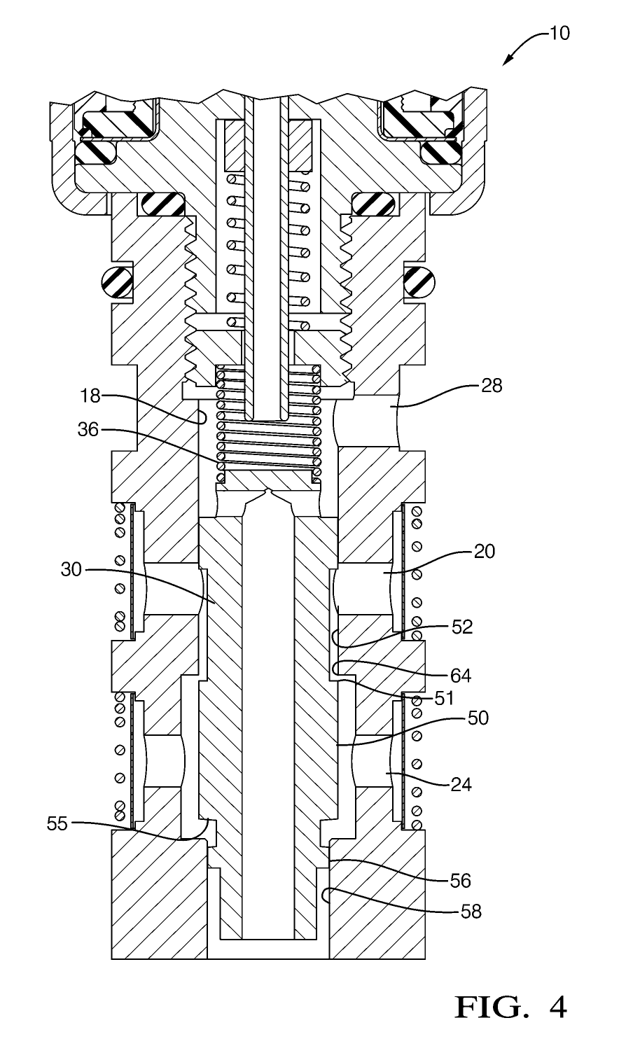

Spool 30 is slideably disposed in longitudinal bore 18 for controlling the flow of working fluid between supply port 20 and control port 24, the flow of working fluid between control port 24 and vent port 28, and the pressure at control port 24. Actuator assembly 14 is used to selectively alter the axial position of spool 30 in longitudinal bore 18 in order to achieve a valve mode selected from the group of high pressure mode (FIG. 2), pressure relief mode (FIG. 3), and pressure regulating mode (FIG. 4). Actuator assembly 14 includes solenoid 32 for producing linear motion and also includes connecting rod 34 for mechanically transmitting linear motion from solenoid 32 to spool 30 when switching from at least one of the valve modes to another of the valve modes. In this way, only one spool 30 is needed because actuator assembly 14 directly/mechanically displaces spool 30 when switching from at least one of the valve modes to another of the valve modes thereby eliminating the need for a second spool to direct working fluid to hydraulically displace spool 30 when switching from at least one of the valve modes to another of the valve modes. Solenoids are well known to those skilled in the art and will not be further discussed herein. Connecting rod 34 is provided to be structurally separate from spool 30. In this instance, structurally separate is meant to include structures that allow relative axial displacement between connecting rod 34 and spool 30 during at least a portion of operation of valve assembly 10. FIG. 4 shows the relative axial displacement between connecting rod 34 and spool 30 when valve assembly 10 is placed in the pressure regulating mode. As can be seen in FIG. 4, the lower end of connecting rod 34 is axially offset from the upper end of spool 30 which is in contrast to FIGS. 2 and 3 which show the lower end of connecting rod in contact with the upper end of spool 30 when the valve assembly is placed in high pressure mode and pressure relief mode respectively.

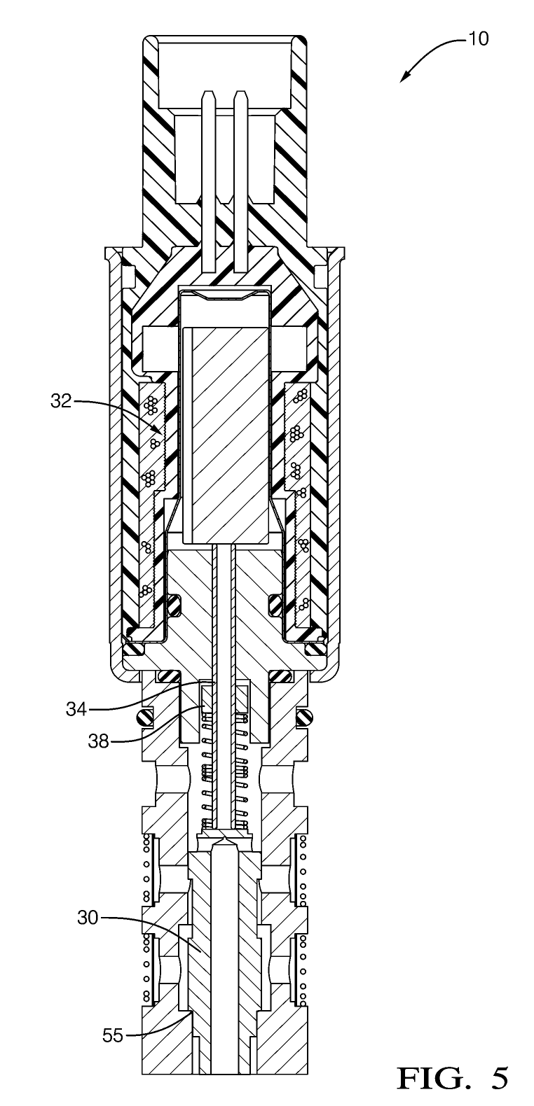

Pressure regulating spring 36 is provided to bias spool 30 away from actuator assembly 14. Pressure regulating spring 36 is grounded by pressure regulating spring stop 38 and is disposed between spool 30 and pressure regulating spring stop 38. In a first embodiment, as shown in FIGS. 1-4, pressure regulating spring stop 38 is fixed to housing 16. Pressure regulating spring stop 38 can be fixed to housing 16 in the manufacturing process to achieve a desired load on pressure regulating spring 36. In a second embodiment, as shown in FIG. 5, pressure regulating spring stop is fixed to connecting rod 34 and will be discussed in more detail later. Pressure regulating spring 36 will be discussed further when the operation of valve assembly 10 is described.

Return spring 40 may be provided to bias connecting rod 34 away from spool 30. Return spring 40 is disposed between pressure regulating spring stop 38 which is fixed to housing 16 and return spring stop 42 which is fixed to connecting rod 34. Return spring 40 will be discussed further when the operation of valve assembly 10 is described.

Spool 30 is provided with vent land 44 which is dimensioned to be in close running tolerance with first end 46 of longitudinal bore 18. Vent land 44 substantially prevents working fluid from being communicated directly to vent port 28. An insignificant amount of working fluid may leak past vent land 44 from supply port 20 to vent port 28 while still considering vent land 44 to substantially prevent working fluid from being communicated directly to vent port 28.

Spool 30 is further provided with inlet annulus 48 which is adjacent vent land 44 and which is in fluid communication with supply port 20. Inlet annulus 48 is dimensioned to be smaller in diameter than vent land 44.

Spool 30 is further provided with intermediate land 50 which is adjacent inlet annulus 48 and which is dimensioned to be in close running tolerance with intermediate portion 52 of longitudinal bore 18. Intermediate land 50 substantially prevents working fluid from being communicated from supply port 20 to control port 24 when in pressure relief mode (FIG. 3). An insignificant amount of working fluid may leak past intermediate land 50 from supply port 20 to control port 24 while still considering intermediate land 50 to substantially prevent working fluid from being communicated from supply port 20 to control port 24 when in pressure relief mode.

Spool 30 is further provided with spool metering edge 51 which is formed by inlet annulus 48 and intermediate land 50. More specifically, spool metering edge 51 is the intersection of intermediate land 50 and the surface connecting the dissimilar diameters of inlet annulus 48 and intermediate land 50.

Spool 30 is further provided with pressure regulating annulus 54 which is adjacent intermediate land 50. Pressure regulating annulus 54 is dimensioned to be smaller in diameter than intermediate land 50.

Spool 30 is further provided with pressure regulating shoulder 55 which is formed by intermediate land 50 and pressure regulating annulus 54. More specifically, pressure regulating shoulder 55 is the surface connecting the dissimilar diameters of intermediate land 50 and pressure regulating annulus 54.

Spool 30 is further provided with pressure relief land 56 which is adjacent pressure regulating annulus 54 and is dimensioned to be larger in diameter than pressure regulating annulus 54 and in close running tolerance with second end 58 of longitudinal bore 18. The function of the various elements of spool 30 will be discussed further when the operation of valve assembly 10 is described.

Longitudinal bore 18 is provided with working annulus 60 formed by enlarged portion 62 of longitudinal bore 18. Working annulus 60 is located between first end 46 of longitudinal bore 18 and second end 58 of longitudinal bore 18.

Longitudinal bore 18 is further provided with bore metering edge 64 of longitudinal bore 18 which is formed by intermediate portion 52 of longitudinal bore 18 and working annulus 60. More specifically, bore metering edge 64 is formed by the intersection of intermediate portion 52 and the surface connecting the dissimilar diameters of working annulus 60 and intermediate portion 52.

Longitudinal bore 18 is further provided with high pressure shoulder 66 which is formed by working annulus 60 of longitudinal bore 18 and second end 58 of longitudinal bore 18. More specifically, high pressure shoulder 66 is the surface connecting the dissimilar diameters of working annulus 60 and second end 58. The function of the various elements of longitudinal bore 18 will be discussed further when the operation of valve assembly 10 is described.

In operation, and now referring to FIG. 2, valve assembly 10 may be selectively placed in high pressure mode. This may be desired, for example, when switching a switchable valve train device from a first mode of operation to a second mode of operation. When placed in high pressure mode, solenoid 32 (FIG. 1) is energized which causes connecting rod 34 to be displaced axially toward spool 30. The axial displacement of connecting rod 34 compresses return spring 40, axially displaces spool 30 until pressure regulating shoulder 55 of spool 30 contacts high pressure shoulder 66 of longitudinal bore 18, and decompresses pressure regulating spring 36. When spool 30 is in this position, control port 24 is not in fluid communication with vent port 28 because pressure relief land 56 of spool 30 is positioned within second end 58 of longitudinal bore 18. An insignificant amount of working fluid may leak past pressure relief land 56 to vent port 28 while still considering control port 24 to not be in fluid communication with vent port 28. At the same time, supply port 20 is in fluid communication with control port 24, thereby causing essentially full pressure from working fluid source 22 (FIG. 1) to be applied to control port 24. An insignificant pressure drop may occur from working fluid source 22 to control port 24 as long as the pressure is sufficient to perform the desired action. Working fluid enters valve assembly 10 through supply port 20 and passes through the passage created between inlet annulus 48 and intermediate portion 52 of longitudinal bore 18. Working fluid then enters working annulus 60 of longitudinal bore 18 and is then communicated to control port 24. The flow path of working fluid when valve assembly 10 is in high pressure mode is shown by Arrow H.

In operation, and now referring to FIG. 3, valve assembly 10 may be selectively placed in pressure relief mode. This may be desired, for example, when switching a switchable valve train device from the second mode of operation to the first mode of operation. Pressure relief mode occurs in the brief time period after solenoid 32 (FIG. 1) is de-energized. When solenoid 32 is de-energized, compressed return spring 40, along with pressurized working fluid acting on pressure regulating shoulder 55 of spool 30, causes connecting rod 34 and spool 30 to be urged toward actuator assembly 14, thereby causing return spring 40 to be decompressed and pressure regulating spring 36 to be compressed. Pressure regulating shoulder 55 may be formed at an incline to high pressure shoulder 66 in order to ensure that pressurized working fluid is able to act on pressure regulating shoulder when pressure regulating shoulder 55 is in contact with high pressure shoulder 66. When spool 30 is in the pressure regulating position in longitudinal bore 18, supply port 20 is not in fluid communication with control port 24 because intermediate land 50 of spool 30 is positioned within intermediate portion 52 of longitudinal bore 18. An insignificant amount of working fluid may leak past intermediate land 50 from supply port 20 to control port 24 while still considering supply port 20 to not be in fluid communication with control port 24. At the same time, pressure relief land 56 of spool 30 is removed from second end 58 of longitudinal bore 18. This allows pressurized working fluid that had been supplied to control port 24 when valve assembly 10 was placed in high pressure mode to now be communicated to vent port 28, thereby relieving pressure from control port 24. In one embodiment, axial passage 68 is provided in spool 30 which is in fluid communication with control port 24 when valve assembly 10 is placed in pressure relief mode. Transverse passage 70 is also provided in spool 30 which intersects axial passage 68 to provide fluid communication between axial passage 68 and transverse passage 70. Transverse passage 70 is in fluid communication with a portion of longitudinal bore 18 that is in fluid communication with vent port 28. The flow path of working fluid when valve assembly 10 is in pressure relief mode is shown by Arrow R.

In operation, and now referring to FIG. 4, valve assembly 10 may be selectively placed in pressure regulating mode. This may be desired, for example, when working fluid pressure only sufficient to lubricate a switchable valve train device is needed without switching between the first and second modes of operation. Pressure regulating mode occurs when solenoid 32 (FIG. 1) is de-energized and after high pressure working fluid has been relieved from control port 24 to vent port 28 when valve assemble 10 was in pressure relief mode. When transitioning from pressure relief mode to pressure regulating mode, compressed pressure regulating spring 36 urges spool 30 away from actuator assembly 14. When spool 30 is urged away from actuator assembly 14, control port 24 is no longer in fluid communication with vent port 28 because pressure relief land 56 of spool 30 is positioned within second end 58 of longitudinal bore 18. An insignificant amount of working fluid may leak past pressure relief land 56 to vent port 28 while still considering control port 24 to not be in fluid communication with vent port 28. At the same time, intermediate land 50 of spool 30 is no longer disposed in intermediate portion 52 of longitudinal bore 18. Therefore, supply port 20 is in fluid communication with control port 24. However, the positioning of spool 30 in longitudinal bore differs from high pressure mode in that spool metering edge 51 of spool 30 is in close proximity to bore metering edge 64 of longitudinal bore 18, thereby causing a pressure differential between the pressure at supply port 20 and the pressure at control port 24. More specifically, the pressure at control port 24 is less than the pressure at supply port 20 while still sufficient to lubricate working device 26 (FIG. 1). When valve assembly 10 is placed in pressure regulating mode, the pressure at control port 24 is also less than the pressure at control port 24 when valve assembly 10 is placed in high pressure mode.

Pressure regulating spring 36 is selected to provide a spring force that will regulate the pressure at control port 24 to a desired level. As working fluid is used to lubricate working device 26, the pressure at control port 24 decreases. This decrease in pressure at control port 24 allows spool 30 to be displaced further away from actuator assembly 14 under the force of pressure regulating spring 36. As spool 30 is displaced, the distance between spool metering edge 51 of spool 30 and bore metering edge 64 of longitudinal bore 18 becomes greater and therefore provides a smaller pressure differential between supply port 20 and control port 24. However, as the pressure increases at control port 24 due to the smaller pressure differential, working fluid will react against pressure regulating shoulder 55 to counteract the force of pressure regulating spring 36 to prevent spool 30 from being displaced too far and thereby preventing too great of a pressure at control port 24. In this way, pressure is regulated at control port 24.

In accordance with a second preferred embodiment of this invention, and now referring to FIG. 5, a valve assembly 10 is shown. The same reference numbers used in the description of the first preferred embodiment will be used in the description of common elements in the second preferred embodiment. The second preferred embodiment is the same as the first preferred embodiment except that return spring 40 (FIGS. 1-4) and return spring stop 42 (FIGS. 1-4) have been eliminated and pressure regulating spring stop 38 is fixed to connecting rod 34. Removing return spring 40 only changes the operation of valve assembly 10 when valve assembly 10 is placed in pressure relief mode. When solenoid 32 is de-energized in the second preferred embodiment after being in high pressure mode, it is only pressurized working fluid acting on pressure regulating shoulder 55 of spool 30 that causes connecting rod 34 and spool 30 to be urged toward actuator assembly 14.

While this invention has been described in terms of the preferred embodiments thereof, it is not intended to be so limited, but rather only to the extent set forth in the claims that follow.

We claim:

1. A valve assembly having a housing with a longitudinal bore, a supply port in fluid communication with said longitudinal bore for receiving working fluid from a working fluid source, a control port in fluid communication with said longitudinal bore for communicating working fluid to and from a working device, and a vent port in fluid communication with said longitudinal bore for returning working fluid to said working fluid source, said valve assembly comprising:
a spool slideably disposed in said longitudinal bore for controlling the flow of working fluid between said supply port and said control port and between said control port and said vent port;
an actuator assembly for selectively altering the position of said spool in said longitudinal bore to achieve a valve mode selected from the group consisting of high pressure mode, pressure relief mode, and pressure regulating mode wherein said actuator assembly comprises a solenoid for producing linear motion and a connecting rod for mechanically transmitting linear motion from said solenoid to said spool when switching from at least one of said valve modes to another of said valve modes, and wherein said connecting rod is structurally separate from said spool.

2. A valve assembly as in claim 1 further comprising a pressure regulating spring for biasing said spool away from said actuator assembly.

3. A valve assembly as in claim 2 further comprising a pressure regulating spring stop fixed to one of said housing and said connecting rod for grounding said pressure regulating spring.

4. A valve assembly as in claim 3 wherein said pressure regulating spring is disposed between said spool and said pressure regulating spring stop.

5. A valve assembly as in claim 1 wherein selection of said high pressure mode causes said spool to be positioned in said longitudinal bore such that said control port is not in fluid communication with said vent port and said supply port is in fluid communication with said control port, thereby causing full pressure from said working fluid source to be applied to said control port.

6. A valve assembly as in claim 1 wherein selection of said pressure relief mode causes said spool to be positioned in said longitudinal bore such that said supply port is not in fluid communication with said control port and said control port is in fluid communication with said vent port, thereby causing pressure to be relieved from said control port.

7. A valve assembly as in claim 1 wherein selection of said pressure regulating mode causes said spool to be positioned in said longitudinal bore such that said control port is not in fluid communication with said vent port and fluid at said control port is regulated to a pressure that is less than pressure at said supply port.

8. A valve assembly as in claim 1 wherein said spool comprises:
a vent land dimensioned to be in close running tolerance with a first end of said longitudinal bore;
an inlet annulus adjacent said vent land and in fluid communication with said supply port, said inlet annulus dimensioned to be smaller in diameter than said vent land;
an intermediate land adjacent said inlet annulus, said intermediate land dimensioned to be in close running tolerance with an intermediate portion of said longitudinal bore;
a pressure regulating annulus adjacent said intermediate land, said pressure regulating annulus dimensioned to be smaller in diameter than said intermediate land; and
a pressure relief land adjacent said pressure regulating annulus, said pressure relief land dimensioned to be in close running tolerance with a second end of said longitudinal bore.

9. A valve assembly as in claim 8 wherein said spool further comprises a spool metering edge formed by said inlet annulus and said intermediate land.

10. A valve assembly as in claim 9 wherein said spool further comprises a pressure regulating shoulder formed by said intermediate land and said pressure regulating annulus for reacting with said working fluid to urge said spool toward said actuator assembly when placed in said pressure relief mode and for reacting with said working fluid to regulate pressure at said control port when placed in said pressure regulating mode.

11. A valve assembly as in claim 10 wherein said longitudinal bore comprises a working annulus formed by an enlarged portion of said longitudinal bore, said working annulus being in fluid communication with said control port and located between said first end of said longitudinal bore and said second end of said longitudinal bore.

12. A valve assembly as in claim 11 wherein said longitudinal bore further comprises a bore metering edge formed by said intermediate portion of said longitudinal bore and said working annulus for interacting with said spool metering edge to regulate said working fluid to a pressure that is less than pressure at said supply port.

13. A valve assembly as in claim 11 wherein said longitudinal bore further comprises a high pressure shoulder formed by said working annulus and said second end of said longitudinal bore for reacting against said pressure regulating shoulder of said spool when said high pressure mode is selected.

14. A valve assembly as in claim 13 wherein said pressure regulating shoulder is inclined to said high pressure shoulder.

15. A valve assembly as in claim 3 wherein said pressure regulating spring stop is fixed to said housing and wherein said valve assembly further comprises:
a return spring stop fixed to said connecting rod; and
a return spring disposed between said pressure regulating spring stop and said return spring stop for biasing said connecting rod away from said spool.
